(19) United States
(12) Patent Application Publication
(10) Pub. No.: US 2017/0313846 A1
(43) Pub. Date: Nov. 2, 2017

(54) RUBBER COMPOUND TO PRODUCE TYRES

(71) Applicant: BRIDGESTONE CORPORATION, Tokyo (JP)

(72) Inventors: Giancarlo COSSU, Roma (IT); Maria Cecilia PALUMBIA, Roma (IT); Ludovica CALIANO, Roma (IT)

(73) Assignee: BRIDGESTONE CORPORATION, Tokyo (JP)

(21) Appl. No.: 15/526,455

(22) PCT Filed: Nov. 13, 2015
(86) PCT No.: PCT/IB2015/058786

§ 371 Date: May 12, 2017

(30) Foreign Application Priority Data
Nov. 13, 2014 (IT) RM2014A000666

(51) Int. Cl. C08K 3/34; C08K 3/30; C08K 3/00

(52) U.S. Cl. CPC C08K 3/34; C08K 3/0033; C08K 3/30

(57) ABSTRACT

A rubber compound comprising a polymer base with a cross-linkable unsaturated chain, a filler, and a vulcanization system. The vulcanization system comprises at least sulphur, one or more vulcanization accelerators, and one or more vulcanization activators. The vulcanization system comprises a vulcanization activator consisting of Zn₂SiO₄.

### TECHNICAL FIELD

The present invention relates to a rubber compound for tyres.

### BACKGROUND ART

Recently, one of the main research areas in the field of tyres concerns a possible substitution of zinc oxide (ZnO) as the vulcanization activator.

Due to its possible environmental implications, there is a requirement for the use of ZnO to be limited. Obviously, an excessive limitation of the ZnO, although on the one hand it would meet the environmental requirements, on the other may compromise the vulcanization of the compound with negative consequences in terms of physical and/or dynamic characteristics of the resulting compounds.

The need was therefore felt for an alternative to the use of ZnO in rubber compounds, which meets the environmental requirements without compromising the physical and/or dynamic characteristics of the compounds.

It has been found that the use of certain zinc salts allows the overall quantity of zinc in the compound to be significantly reduced.

### DISCLOSURE OF INVENTION

The subject of the present invention is a rubber compound comprising a polymer base with cross-linkable unsaturated chain, a filler and a vulcanization system; said vulcanization system comprising at least sulphur, one or more vulcanization accelerators and one or more vulcanization activators; said compound being characterized in that said vulcanization system comprises a vulcanization activator consisting of Zn₂SiO₄.

Here and below, the term “polymer base with cross-linkable unsaturated chain” means any natural or synthetic non cross-linked polymer able to take on all the chemical-physical and mechanical characteristics typically taken on by the elastomers following cross-linking (vulcanization) with sulphur-based systems.

Preferably, said vulcanization activator consisting of Zn₂SiO₄ is present in the compound in a quantity ranging from 0.01 to 2.5 phr, more preferably from 0.01 to 1.5 phr.

Preferably, the vulcanization activator consisting of Zn₂SiO₄ is the only vulcanization activator in said vulcanization system.

Preferably, Zn₂SiO₄ represents the only source of Zn in the compound.

A further subject of the present invention is a tyre portion produced with the compound subject of the present invention.

A further subject of the present invention is a tyre comprising a portion produced with a compound subject of the present invention.

A further subject of the present invention is the use of Zn₂SiO₄ as a vulcanization activator in rubber compounds.

### BEST MODE FOR CARRYING OUT THE INVENTION

Examples are given below for illustrative non-limiting purposes for a better understanding of the present invention.

### Examples

—Vulcanization Tests—

To test the capacities of Zn₂SiO₄ as a vulcanization activator compared to ZnO, an experimental method was formulated based on the vulcanization reaction of a model molecule in the presence of a vulcanization system comprising alternatively ZnO or Zn₂SiO₄ and squalene as a molecule representative of the polymer base. Occurrence of the vulcanization was monitored by means of the HPLC analysis technique.

Tables I-V show the compositions in phr of the 10 reaction mixtures (A-J) used for the vulcanization tests.

TABLE I

| | |
|---|---|
| A | B |

| | |
|---|---|
| Squalene | 100 |
| CBS | 1.2 |
| Sulphur | 2 |
| Stearic acid | 2 |

| | | |
|---|---|---|
| ZnO | 0.5 | — |
| Zn₂SiO₄ | — | 0.5 |

TABLE II

| | |
|---|---|
| C | D |

| | |
|---|---|
| Squalene | 100 |
| CBS | 1.2 |
| Sulphur | 2 |
| Stearic acid | 2 |

| | | |
|---|---|---|
| ZnO | 1.5 | — |
| Zn₂SiO₄ | — | 1.5 |

TABLE III

| | |
|---|---|
| E | F |

| | |
|---|---|
| Squalene | 100 |
| CBS | 1.2 |
| Sulphur | 2 |
| Stearic acid | 2 |

| | | |
|---|---|---|
| ZnO | 2.5 | — |
| Zn₂SiO₄ | — | 2.5 |

TABLE IV

| | |
|---|---|
| G | H |

| | |
|---|---|
| Squalene | 100 |
| CBS | 1.2 |
| Sulphur | 2 |
| Stearic acid | 2 |

| | | |
|---|---|---|
| ZnO | 3.0 | — |
| Zn₂SiO₄ | — | 3.0 |

TABLE V

| | |
|---|---|
| I | J |

| | |
|---|---|
| Squalene | 100 |
| CBS | 1.2 |
| Sulphur | 2 |
| Stearic acid | 2 |

| | | |
|---|---|---|
| ZnO | 5.0 | — |
| Zn₂SiO₄ | — | 5.0 |

For each of the above reaction mixtures, the degree of vulcanization of the squalene was determined by the HPLC analysis technique referring to the chromatographic signals typical of the cross-linking products. The results are reported in Tables VI and VII in an indexed form with respect to the value found for the compounds with ZnO at the same concentration of phr (0.5; 1.5; 2.5; 3.0; 5.0).

TABLE VI

| | A | B | C | D | E | F |
|---|---|---|---|---|---|---|
| Vulcanization | 100 | 333 | 100 | 250 | 100 | 167 |
| index | | | | | | |
| Moles of Zn | 0.006 | 0.004 | 0.018 | 0.013 | 0.031 | 0.022 |

TABLE VII

| | G | H | I | J |
|---|---|---|---|---|
| Vulcanization | 100 | 50 | 100 | 63 |
| index | | | | |
| Moles of Zn | 0.037 | 0.027 | 0.061 | 0.045 |

From the values of Tables VI and VII it is clear that Zn₂SiO₄ at low concentrations has an effectiveness in terms of vulcanization activation significantly higher than that of the ZnO.

In particular, from the values of Tables VI and VII it can be seen that Zn₂SiO₄ is more effective than the ZnO when used in concentrations below 3 phr (values of Table VI), while it is less effective than the ZnO when used in concentrations above 3 phr (values of Table VII).

For a better understanding of the advantages of the present invention, Tables VI and VII also show the number of moles of Zn present in each of the compounds A-J. In said regard, the values of Tables VI and VII show that it is possible to drastically reduce the presence of Zn in the compound while maintaining the vulcanization capacities of the compound unchanged.

In fact, the possibility of obtaining a high degree of vulcanization using low quantities of Zn₂SiO₄ is necessarily reflected in a significant reduction of the overall quantity of Zn in the compound.

1. A rubber compound comprising a polymer base with a cross-linkable unsaturated chain, a filler, and a vulcanization system; said vulcanization system comprising at least sulphur, one or more vulcanization accelerators, and one or more vulcanization activators; wherein said vulcanization system comprises a vulcanization activator consisting of Zn₂SiO₄.

2. A rubber compound according to claim 1, wherein said vulcanization activator consisting of Zn₂SiO₄ is present in the compound in a quantity ranging from 0.01 to 2.5 phr.

3. A rubber compound according to claim 1, wherein said vulcanization activator consisting of Zn₂SiO₄ is present in the compound in a quantity ranging from 0.01 to 1.5 phr.

4. A rubber compound according to claim 1, wherein said vulcanization activator consisting of Zn₂SiO₄ is the only vulcanization activator in said vulcanization system.

5. A rubber compound according to claim 1, wherein Zn₂SiO₄ is the only source of Zn in the compound.

6. A tyre portion manufactured with a compound according to claim 1.

7. A tyre comprising a portion according to claim 6.

8. A use of Zn₂SiO₄ as a vulcanization activator in rubber compounds.

9. A use according to claim 8, wherein said vulcanization activator consisting of Zn₂SiO₄ is present in the compound in a quantity ranging from 0.01 to 2.5 phr.

10. A use according to claim 8, wherein said vulcanization activator consisting of Zn₂SiO₄ is present in the compound in a quantity ranging from 0.01 to 1.5 phr.
